(19) United States
(12) Patent Application Publication
(10) Pub. No.: US 2016/0110428 A1
(43) Pub. Date: Apr. 21, 2016

(54) METHOD AND SYSTEM FOR FINDING LABELED INFORMATION AND CONNECTING CONCEPTS

(71) Applicant: Multi Scale Solutions Inc., Lexington, KY (US)

(72) Inventors: Aleksey V. Vasenkov, Lexington, KY (US); Irina A. Vasenkova, Huntsville, AL (US)

(21) Appl. No.: 14/518,432

(22) Filed: Oct. 20, 2014

(51) Int. Cl. G06F 17/30

(52) U.S. Cl. CPC G06F 17/30539; G06F 17/30289; G06F 17/301; G06F 17/30699

(57) ABSTRACT

It is possible to partially or fully automate analysis of synthetic data to find labeled information and authored connecting concepts. This can help individuals to find experts in relevant domains, to identify non-obvious solutions to their R&D problems, to serve as a catalyst (input) for innovation, or to categorize prior art relevant to a technological concept seeking venture capital funding, a scientific area for new product development, and/or a patent application in question.

### FIELD

The present disclosure can be used to implement methods and systems for finding labeled information and authored connecting concepts via the use of TDM (text and data mining).

### BACKGROUND

There is an unprecedented growth in synthetic big data such as research articles, Ph.D. theses, patents, test reports and product description reports. R&D departments and organizations experience increasing difficulties in analyzing massive synthetic big data to identify existing solutions to their problems and to find collaborators (experts) in relevant domains. Existing search engines are incapable of intelligent processing of information contained in these synthetic big data. Similarly, there is exponential growth in the volume of prior art synthetic data that must be analyzed to evaluate a technological concept seeking venture capital funding, to investigate a specific scientific area for new product development, and to confirm that a patent request does not violate or overlap already patented technology. It can be expected that the cost of prior art analysis will escalate because of this, and so many organizations of different types and sizes will require massive increases in staffing and budget for activities involving prior art analysis. Accordingly, there is a need in the art for technology which can partially or fully automate the analysis of synthetic data.

### SUMMARY

The technology described herein can be implemented in a variety of ways. For example, based on this disclosure, one of ordinary skill in the art could implement a method comprising: receiving a set of keywords representing prior knowledge, preparing an analysis database comprising a set of information items, generating a plurality of topics comprising multiple topics for each information item in the analysis database, calculating a similarity for each pair of topics from a plurality of pairs of topics, determining whether each pair of topics should be included in a result set based on the similarities calculated for those topics, and presenting the result set.

Other implementations of the disclosed technology are also possible, including methods and systems for finding labeled information and authored connecting concepts within the same or different documents or clusters of documents to identify existing solutions to R&D problems based on the information hidden in synthetic data, to serve as a catalyst (input) for innovation, to categorize prior art relevant for different applications, or to find experts in relevant domains. Accordingly, the protection provided by this document, or by any related document, should not be limited to covering only the specific types of implementations described in this summary.

### BRIEF DESCRIPTION OF THE DRAWINGS

FIG. 1 shows a method which can be used in finding and storing labeled information and authored connections.

FIG. 2 compares labels of clusters mined using a system implemented using the disclosed technology (left panel) with topics obtained using ScienceDirect (right panel) for the “transcriptional interference” search term.

FIG. 3 shows results of searching for “transcriptional interference” and “CCAAT” using both a system implemented using the disclosed technology (left panel) and PubMed (right panel).

FIG. 4 illustrates non-obvious connection Histone between clusters representing two partial solutions CCAAT and Chromatin insulator.

FIG. 5 shows how a system implemented using the disclosed technology can enrich a PubMed search by finding connectable documents (research articles).

FIG. 6 illustrates how a system implemented using the disclosed technology can place individual high-scored patents found by Delphion search engine (right panel) in different clusters with labels (left panel).

FIG. 7 shows an example of two connectable patents found by a system implemented using the disclosed technology.

FIG. 8 depicts an architecture which can be used in implementing a present system for developing and storing labeled information and authored connections.

FIG. 9 depicts a method for identifying a particular type of legally significant connection.

### DETAILED DESCRIPTION

### Glossary

The following terms are used throughout and unless indicated otherwise have the following meaning:

“Authored connection” is a connecting concept that contains name of one or more authors who authored this concept and may include author's affiliation, and contact information.

“Expert” is a professional with proven expertise in one or several research and development domains. Experts include, but are not limited to university faculty, independent consultants, and researchers from industry, academia, national laboratories and centers, and hospitals.

“Connection” or “connecting concept” is a label comprising keywords determined by two or more topics and may include labels of clusters and contributing authored documents.

“Cluster” is a collection of similar documents.

“Document” is a summary, an excerpt of, or the full text of any written, printed, or electronic matter such as book, ebook, patent, published patent application, published article, or web page that contains information or evidence.

“Keywords” are sets of one or more words that describe, represent, or are otherwise characteristic of content. In this document, a keyword which includes multiple words is often referred to as a “keyphrase.”

“Labeled information” is defined as any labeled cluster or any labeled topic or a combination thereof.

“Label” of any information item is a set of high-frequency keywords which that item comprises.

“Prior knowledge” is defined as a combination of preexisting experiences and knowledge.

“Problem” is defined as any technological question, phenomenon or issue.

“Project leader” is a person who introduces a problem and specifies the requirements that can include, but are not limited to keywords describing or representative of each challenge of the problem, the project leader's knowledge of the problem, and his or her research interests, process, service, or issue.

“Stopwords” are words that are filtered out prior to, or after, processing of synthetic data.

“Solution” is a research idea mined in response to a problem.

“Synthetic data” is defined as a collection of information that is not obtained by direct measurement or simulation and includes, but is not limited to research articles, patents, Ph.D. thesis, test reports and product description reports.

“Topic” is a set of words that frequently occur together in the context of a document or cluster of documents.

“TDM” denotes any method that is capable of discovering patterns in synthetic data.

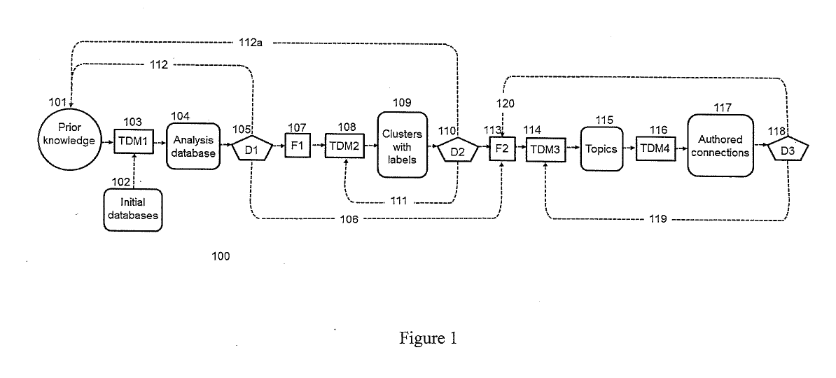

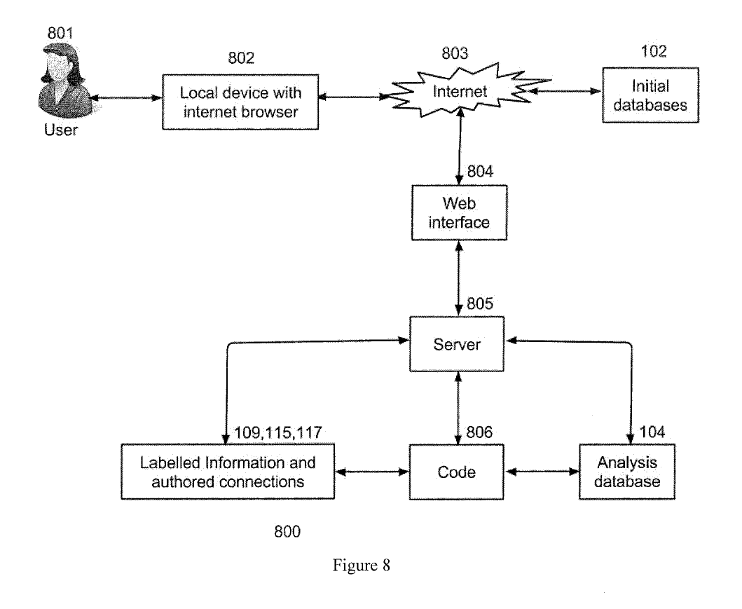

Turning now to the figures, FIG. 1 illustrates a method for finding and storing labeled information and authored connections between documents or clusters of documents which could be implemented by one of ordinary skill in the art in light of this disclosure. Initially, in the method of FIG. 1, prior knowledge [101] is provided to a computer programmed based on the disclosed technology to help define the problem domain in which labeled information and connections will be identified, and to assist in the subsequent identification of the labeled information and connections. This prior knowledge can be received by the computer, for example, as a combination of a list of stopwords and set of keywords and keyphrases which describe the problem domain at a high level (e.g., the stopwords and keywords and keyphrases can be manually entered using an interface provided by the computer or uploaded by a user to a system implemented to use the described technology such as shown in FIG. 8). To illustrate, if a method such as shown in FIG. 1 were used by an individual whose knowledge of color mixing was limited to color mixing concepts for additive color systems, then the prior knowledge could include a list of the following keywords: green, blue, red, and while. These keywords could be used because green, blue, and red are the primary colors used in additive color systems and are known to produce white when mixed together (see en.wikipedia.org/wiki/Additive_color).

Of course, other approaches to providing prior knowledge are also possible, and a method could be implemented along the lines shown in FIG. 1 without requiring a user to provide a list of keywords and keyphrases. For example, the provision of prior knowledge could be accomplished by uploading or entering text suitable for automatic extraction of set of keywords and keyphrases. Such a text could be, for example, a webpage, an article, a patent, a solicitation or a report which had previously been identified as being relevant to the problem domain of interest (e.g., by a project leader). Once the text had been uploaded, entered, or otherwise made available to a system implemented based on this disclosure, keywords and keyphrases similar to those which a user might otherwise have entered directly could be automatically extracted from that text by using, for example, topic identification software such as the maui-indexer available at code.google.com/p/maui-indexer.

Continuing with the discussion of FIG. 1, after the prior knowledge [101] has been provided, a first text data mining process [103] is applied to a corpus of documents (e.g., a public database such as PubMed (www.ncbi.nlm.nih.gov/pubmed), a private database such as Google, Delphion (www.delphion.com), ScienceDirect (www.sciencedirect.com/), or some kind of synthetic corpus, such as a combination of multiple public and/or private databases) using the prior knowledge. For example, in a test of applying a system implemented with the disclosed technology to color mixing concepts, the key words green, blue, red, and white were used to extract 22 webpages from the webpage database at www.google.com. Extracted webpages were parsed to 1,079 paragraphs, where each paragraph was treated as a separate document. Resulting documents were then used to create an analysis database [104] which was subjected to a decision D1 [105] whether to use the content of the analysis database to update prior knowledge [101] via pivot loop [112], to proceed with the clustering steps [107]-[109], or to bypass these steps by proceeding via [106] to the second filtering process [113]. The update of prior knowledge can be desirable, for example, when a tiny number of documents is found in the analysis database (e.g., the number of documents is so small that manual review of those documents would be feasible). In this case, prior knowledge can be modified via pivot loop [112] to make it more generic. Similarly, if the analysis database comprises of too many documents that might be difficult to analyze using the disclosed technology within the reasonable time, prior art may be updated to make it more specific. Bypassing clustering steps [107]-[109] via [106] is recommended when there is a relatively small number of documents in the analysis database [104], but each of these documents comprises of several logical document fragments such as paragraphs. If there is a relatively larger number of documents in the analysis database but each of these documents includes a single logical expression, generally the decision [105] will be to proceed with the clustering steps [107]-[109]. In the clustering steps [107]-[109], a second data mining process [108] will be performed, and will typically be preceded by a first filtering process [107] that removes stopwords from documents in the analysis database. These stopwords can be either received from a user or public resources, for example, at patft.uspto.gov/netahtml/PTO/help/stopword.htm, or a can be obtained from a combination of sources (e.g., a publicly available list supplemented by a user who could add stopwords based on his or her knowledge of the relevant domain).

In the clustering steps [107]-[109], the second text data mining process [108] can be used to organize the filtered contents of the analysis database [104] into a set of labeled clusters [109]. Preferably, when implementing the disclosed technology, the parameters of this second text data mining process [108] will be chosen so as to maximize the generation of clusters [109] and to ensure that many cluster labels are generated. For example, in the test of applying a system implemented using the disclosed technology to additive color mixing concepts, the Lingo algorithm by Osiński and Weiss 2004, which is based on the Singular Value Decomposition method that includes a factorization of a complex matrix, was used to maximize the generation of clusters by maximizing number of seed clusters and increasing similarity threshold for documents that are put in the same cluster. The Lingo algorithm by Osiński and Weiss 2004 was chosen for illustration because of its ability to supply meaningful labels for clusters. This is achieved due to the fact that the Lingo algorithm, first, compiles a set of descriptive labels from high frequency word or phrases from an entire collection of documents, second, builds clusters by grouping similar documents, and, finally, matches each cluster with a descriptive label from the set obtained in the first step. In this algorithm, if the matching process in the final step fails for any particular cluster then documents from this cluster can be put in a cluster with some generic name. Although automatic cluster labeling is preferable in a system implemented using the disclosed technology, it is not a compulsory requirement. As an alternative, documents in analysis database [104] can be clustered based on the k-means clustering technique described at http://en.wikipedia.org/wiki/K-means_clustering and then manually named by a user.

An illustration of data mining [108] was conducted with keywords green blue red white representing prior knowledge [101] (with keywords Magenta, Cyan and Yellow used for testing completeness of clusters) on analysis database [104] of 1,079 documents described above which was filtered [107] using for English stopwords available at http://project.carrot2.org/download.html. This generated 63 labeled clusters [109], including clusters labeled with keywords from the original prior knowledge which were selected for further analysis (here and further on, parenthetical numbers following cluster labels refer to the number of documents in the clusters): Red(281), Blue(264), Green(253), and White (184). Then, clusters whose labels were semantically related to the original keywords: Magenta(78), Cyan(82), and Yellow(163) were added to the set of clusters for further analysis. The semantic relationship here is that Red, Blue, and Green are the primary colors in the additive color system, while Magenta, Cyan and Yellow are the secondary colors in the same color system. Since the generated cluster labels in this example include all keywords from the original prior knowledge as well as those semantically related terms, searching and clustering processes was terminated.

After a set of labeled clusters has been generated, the process of FIG. 1 continues with a decision D2 [110] of whether to proceed with analysis based on those labeled clusters, or to use information from those labeled clusters to update prior knowledge via pivot loop [112a] and repeat all the above-described steps, or to repeat clustering processes [108] described above via pivot loop [111] with an updated set of keywords. Here, keywords are updated based on the labels of clusters [109] (e.g., the set of keywords can be modified to include the labels identified for the clusters). The repetition of the searching and/or clustering processes could be useful for purposes such as making sure that there are clusters with labels which contain answers to one or more question incorporated in prior knowledge which can be subjected to further analysis. For example, searching and/or clustering processes described above can be repeated with prior knowledge modified at the end of each iteration to include keywords and keyphrases from the search and/or clustering until clusters with labels that include all keywords and keyphrases from the original and modified prior knowledge are generated. Of course, alternatives, such as determining whether to repeat the clustering and/or searching steps based on whether the labels of the clusters cover all keywords in a set of keywords which could be provided with the prior knowledge but not used in searching the initial databases [102] (e.g., a list of secondary colors in the additive color mixing example) are also possible, and will be immediately apparent to those of skill in the art in light of this disclosure. Accordingly, the above discussion should be understood as being illustrative only, and should not be treated as limiting.

Depending if a determination [105] has been made to proceed analysis with the clustering steps [107]-[109] or a path for individual document [106], a third text data mining process [114] can be applied to one or more of the labeled clusters (e.g., those clusters with labels which appear relevant to the problem domain being analyzed) or individual documents to identify topics to use in defining connections, respectively. This third text data mining process [114] is typically preceded by a second filtering process [113] that removes stopwords from the labeled clusters or individual documents prior to topic generation. Stopwords can be either provided by a user or received from public resources, for example, at http://patft.uspto.gov/netahtml/PTO/help/stopword.htm, or a combination of therein. Stopwords used in the second filtering process [113] are typically different from those used in the first filtering process [107], though this is not a necessary feature and, indeed, it is possible that the second filtering process [113] might be omitted in some implementations of the disclosed technology.

A third text data mining process [114] can be performed, for example, using a method that treats a document or a cluster of documents as a bag of words and phrases. One such method, which was used in the additive color mixing example described above, is the Latent Dirichlet Allocation (LDA) model outlined at http://en.wikipedia.org/wiki/Latent_Dirichlet_allocation. Documents in LDA are assumed to be sampled from a random mixture over latent topics representing concepts in documents, each author is represented by a probability distribution over topics, and each topic is characterized by a distribution over keywords, keyphrases, and authors. The topic distribution is assumed to have a Dirichlet prior (i.e., an unobserved group of topics) that links different documents. Use of LDA to generate topics [115] can be illustrated for 9 clusters each labeled with a specific color. LDA modeling in a method such as presented in FIG. 1 requires a few parameters to be set. For example, a number of output topics has to be chosen. Preferably, this number will be large enough, approximately 1,000 topics per cluster when the decision [105] has been made to proceed via the clustering steps [107]-[109], or 100 topics per document when the cluster generation steps have been bypassed via [106]. This is to ensure a generation of at least a few pairs of topics belonging to different clusters with an acceptable strength of similarity (e.g., high, medium, or low strength of similarity) or at least a few pairs of topics belonging to different logical document fragments such as paragraphs with an acceptable strength of similarity when LDA modeling is performed on individual documents that each comprises several logical fragments such as paragraphs. The logic here is that even very dissimilar clusters or individual documents with a few logical fragments can contain a small fraction of similarly labeled topics that can be identified using the disclosed technology. Assuming that strength of similarity varies from 0 or no similarity to 1 or full similarity, different strengths of similarity can be classified as follows: a low strength of similarity is between 0.1 and 0.3, a medium length of similarity is between 0.3 and 0.6, and a high strength of similarity is between 0.6 and 1.

Other parameters which can be selected when using LDA modeling in a method such as shown in FIG. 1 can include prior weight of the topics in a document (generally this will be the same for all topics, in which case it will be denoted with the Greek letter α, though it can differ from topic to topic, in which case differing weights can be denoted as α₁ . . . αₖ where k is the number of topics), prior weight of words in a topic (like the prior weight of topics, this will generally be the same for all words, in which case it will be denoted with the Greek letter β, though it can differ from word to word, in which case the differing weights will be denoted as β₁ . . . βᵥ, where v is the number of words in a vocabulary for the documents), prior weight of authors in a topic (like the prior weight of words, this will generally be the same for all authors, in which case it will be denoted with the Greek letter γ, though it can differ from author to author, in which case the differing weights will be denoted as γ₁ . . . γₘ, where m is the number of authors in a set of authors for the documents), and number of iterations to reach a converged solution. The parameter α can be chosen so that only a few topics per document are generated in the case of clusters or only a few topics per logical document fragments such as paragraphs are generated when TDM3 is performed on individual documents. Similarly, the parameters β and γ can be selected so that only a few words and a few authors per topic are generated, respectively, to facilitate the identification of large number of connections with high and medium strength. For example, in the color mixing test, the following parameters were used: the number of topics=1000, α=0.1, β=0.01, and the number of iterations to reach a converged solution was 6,000. Other parameter values can be used though the values of α and β will generally be less than 1, and will preferably be low so as to cause the model to prefer sparse topic and word distributions. In this example, a distribution over authors was not obtained, though the approach outlined above could have been used to identify a distribution of topics over authors if information associating the extracted documents with their authors had been available.

Going back to the example with color mixing concepts, clusters Magenta(78), Cyan(82), Red(281), Blue(264), Green(252), White(184), Yellow(163) selected for further analysis were filtered via [107] for English stopwords available at en.wikipedia.org/wiki/Wikipedia:Historical_archive/Common_words,_searching_for_which_is_not_possible. Then, LDA modeling represented documents in filtered Magenta(78), Cyan(82), Red(281), Blue(264), Green(252), White(184), Yellow(163) clusters described above as random mixtures over latent topics, where each topic was characterized by a distribution over words.

Of course, it should be understood that the above disclosure is intended to be illustrative only, and that topics [115] can be identified in other manners as well. For example, an alternative approach, which could be used to generate topics comprising sets of words that frequently occur together in the context of documents or clusters of documents is to use a diffusion-based model. In such a model, a term-document matrix A (n×m matrix) can be introduced, where n is size of the vocabulary of the analysis database and m is number of documents or clusters of documents in analysis database. Then the normalized term-term matrix T can be constructed as

T=D^{-1/2}=D^{-1/2}WD^{-1/2}, (1)

where W is A A^{T}, A^{T} is the transpose matrix of A, D is the diagonal matrix whose entries are the row sums of W. Then, the diffusion scaling functions φⱼ and wavelet functions ψⱼ at different levels j can be computed using the diffusion wavelet algorithm outlined at en.wikipedia.org/wiki/Diffusion_wavelets:

φⱼψⱼ=DWT(T,I,QR,J,ε) (2)

Here, I is an identity matrix; J is the max step number; s is desired precision, QR is a sparse QR decomposition. At each level j, [φⱼ]_{φ}_{₀}, the representation of the basis functions in the original space, is computed as follows:

[φⱼ]_{φ}_{₀}=[φⱼ]_{φ}_{ⱼ₋₁}[φⱼ₋₁]φⱼ₋₂ . . . [φ₁]_{φ}_{₀}[φ₀]_{φ}_{₀} (3)

Here, each column vector in [φⱼ]_{φ}_{₀} represents a topic at level j. Finally, multistate embedding of the corpora at scale j can be found as [φⱼ]_{φ}_{₀}^{T}A. This can be used to automatically select a topical hierarchy as well as topics at each level without the need for input beyond the documents or clusters to be analyzed.

However it takes place, after the generation of topics [115] is complete, the process of FIG. 1 [116] uses the generated topics to identify connections [117] between different clusters (or other items of labeled information, such as if the clustering steps [107]-[109] were skipped by following path [106] after decision [105] in the process of FIG. 1). This can be done, for example, for each pair of labeled clusters using high-throughput similarity calculations for each pair of topics belonging to the clusters in question. Alternatively, it is possible that pairs taken from less than all labeled clusters could be tested for connections. For example, a subset of clusters to test for connections can be identified by selecting clusters with labels which comprise the keywords and keyphrases from the prior knowledge. Similarly, rather than calculating similarity for each pair of topics belonging to the clusters in question, it is possible that only a subset of topics could be tested (e.g., for any two clusters, the only pairs of topics which would be tested would be those made up of a topic in a first cluster and a similarly labeled topic in the second cluster, such as s topic in the second cluster which had a label which was a plural of the label for the topic in the first cluster).

To illustrate, let us consider high-throughput similarity calculations based on Kullback-Leibler (KL) distance. In such an example, similarity between a pair of topics zᵢ and zⱼ can be calculated from the following expression:

S(zᵢ,zⱼ)=1−log [−KL(zᵢ,zⱼ)], (4)

where KL(zᵢ,zⱼ) is the Kullback-Leibler (KL) distance for topics zᵢ and zⱼ:

KL(zᵢ,zⱼ)=Σₓ₌₁^{N}[φᵢₓ log(φᵢₓ/φⱼₓ)] (5)

Here, φ is the topic-word distribution and the summation is over all overlapping words for topics zᵢ and zⱼ. The goal of KL divergence is to evaluate whether two sets of samples came from the same distribution. In practice, many topics have a small fraction of overlapping words and phrases. In this case, smoothing techniques that reduce noise in calculated KL divergence can be used. Such use is illustrated by a back-off model which discounts all term frequencies that appear in the topics for which KL divergence is calculated and set a probability of unknown words for all the terms which are not in these topics. This overcomes the data sparseness problem which can cause noise in KL divergence calculations. In the example with color mixing concepts, KL divergence calculations were used to find connections with high or medium strength between topics belonging to different clusters, though other types of calculations, such as calculating the cosine similarity or Jaccard similarity coefficient of pairs of topics, could also be used, and so the discussion of KL distance calculations should not be treated as implying that use of that particular approach is necessary for implementing the disclosed technology.

Once they have been identified these types of connections can be used for a variety of purposes, including using unexpected connections to identify gaps in the knowledge of the project leader. For example, in the color mixing example, the connection Primary(Primaries) was found to connect the following pairs of clusters: Yellow(163) and Cyan(82), Magenta(78) and Cyan(82), and Magenta(78) and Yellow(163). These connections are unexpected because they are inconsistent with the knowledge of additive color mixing represented by the originally presented keywords (i.e., Yellow, Cyan and Magenta are not primary colors in additive color mixing), and can be used to identify a gap (which can be filled by the underlying documents which contributed to those connections) in the knowledge of the project leader, because Yellow, Cyan and Magenta are primary colors in the CYMK subtractive model used in color printing, a color mixing system which was entirely absent from the prior knowledge.

Another illustration of how a connection from the color mixing example could identify gaps in the knowledge of the project leader is the fact that the same label (i.e., Primary) was used for topics connecting the following clusters: Blue(264) and Red(281), Yellow(163) and Red(281), and Yellow(163) and Blue(264). Like the connections described above, these connections are unexpected because they are inconsistent with the prior knowledge of additive color mixing (in which yellow is a secondary color), and can identify gaps in the prior knowledge because these connections reflect the existence of the RYB (red, yellow, blue) subtractive model used in mixing paint, yet another color mixing system which was entirely absent from the prior knowledge.

Connections other than those which are inconsistent with prior knowledge are not the only type of unexpected connections which can be used to identify gaps in the prior knowledge. To illustrate, consider Fovea, identified in the color mixing example as connecting the Green(252) and Red(281) clusters. This connection is unexpected, not because it is inconsistent with prior knowledge of additive color mixing, but because the fovea, or fovea centralis, is a part of the eye that is responsible for central vision and is known to express pigments that are sensitive to green and red light. This connection can identify gaps in prior knowledge, because the initial keywords for additive color mixing did not include any reference to visual anatomy in general, or to the fovea in particular.

After connections between clusters have been identified, the process of FIG. 1 proceeds with another determination of whether to repeat one or more of the previous steps. For example, while it is possible that (as illustrated above) the connections may include unexpected connections which can be used to identify gaps in knowledge, it is also possible that the identified connections may simply reflect information which was cumulative with what was already known. For example, a connection White between the clusters Yellow(163) and Blue(264) could illustrate the result of mixing blue and yellow lights in an additive color mixing system. However, given that the prior knowledge was prior knowledge of additive color mixing, this connection may not provide any new information of interest. In such a situation, the connection(s) which are not of interest like the word White could be added to a stopword filter and the process of FIG. 1 could be repeated with the updated stopword filter via [120] to identify new sets of topics and connections between clusters (or other items of labeled information, such as documents in the event that the clustering steps [107]-[109] had been skipped in a method such as shown in FIG. 1). Alternatively, the process can be repeated without updating stopword filter but by setting a different seed set for the random number generator. This will generate a different set of topics in [114] since documents in LDA method are chosen randomly over latent topics and this choice is determined by the random number generator. This alternative is shown by [119] in FIG. 1. The described pivot loops can be repeated one or more times (including repetitions where unexpected connections are added to the stopword filter, such as after those connections have been investigated or added to a list for further study) until all connecting concepts have been found (e.g., until so many words have been added to the list of stopwords that it is no longer possible to find any connections having at least a threshold strength). At this point (or sooner, such as if a connection of sufficient value to justify its immediate investigation is identified) the experts/authors who have written most extensively on the topics which were identified as worthy of further study, and/or the documents relevant to those topics, can be identified or, if no topics were identified as worthy of further study, the process can be treated as having confirmed that the prior knowledge represented by the keywords used for searching appears to be complete.

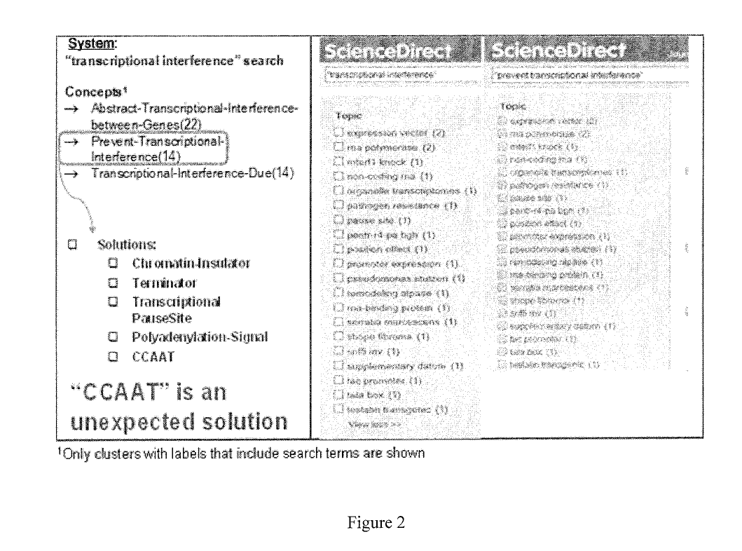

It should be understood that the above explanation is intended to be illustrative only, and that variations could be implemented without undue experimentation by, and will be immediately apparent to, those of ordinary skill in the art. To illustrate, consider the application of the disclosed technology to the promoter interference problem, a real-life biotechnology challenge described in K. E. Shearwin et al. (2005), “Transcriptional interference—a crash course”, TRENDS in Genetics 21(6): 339-345. In such a case, the prior knowledge could include a list of words and phrases relevant to that problem, such as “transcriptional interference”, “promoter interference”, “promoter suppression” and “promoter occlusion.” Prior knowledge in this example was used to search Scirus database (www.sciencedirect.com/scirus/), and the results were used to create, via a first text data mining process [103], an analysis database of 2,946 references relevant to the promoter interference problem. This database was filtered [107] via for English stopwords using the list of stopwords available at http://project.carrot2.org/download.html. Then, the second text data mining data mining process [108] was performed with query term “transcriptional interference” from prior knowledge (a keyword that describes the promoter interference problem in prior knowledge) on the database of 2,946 references described above to automatically generate a set of clusters, some of which are presented in FIG. 2. One of these clusters, labeled Prevent-transcriptional-interference(14), contains different solutions for how to prevent transcriptional interference. Uniqueness of this cluster was confirmed by tests with ScienceDirect that was unable to generate such a cluster. A person of ordinary skill would expect to find solutions in this cluster to the promoter interference problem based on label for the cluster and the query term used in data mining. Also, this person is expected to be able to name these solutions by reading documents in this cluster since these documents are abstracts of science journals written so that readers can learn the main results without analyzing the entire article as explained, for example, at www.aap.org/en-us/about-the-aap/Committees-Councils-Sections/Section-on-Hospital-Medicine/Documents/Abstracts101-AMA_JournalInfo.pdf.

After this cluster was identified, names of solutions from this cluster like terminator, chromatin-insulator, CCAAT, transcriptional-pause-sites, and polyadenylation-signal were used as new query terms for performing clustering steps [107]-[109] instead of “transcriptional interference” in prior knowledge. In this second iteration of the clustering steps, the second text data mining process [108] was repeated via [111], resulting in a new set of clusters such as Terminator(61), Chromatin-Insulator(15), CCAAT(14), Transcriptional-Pause-Sites(6), and Polyadenylation-Signal(16). Since the generated set of clusters contained cluster labels with all solutions found at the previous iteration, no further repetition of the searching and/or clustering steps was performed. Obtained clusters were then filtered [113] for English stopwords available at en.wikipedia.org/wiki/Wikipedia:Historical_archive/Common_words,_searching_for_which_is_{—} not_possible.

An experiment for finding connecting topics was further conducted for the clusters with Polyadenylation-signal and Transcriptional-pause-site labels. Polyadenylation Signal and Transcriptional pause sites are the genetic elements that are known to synergistically terminate transcription in eukaryotes and can be viewed as functional blocks or partial solutions of a combined transcriptional terminator solution. Mining for connecting topics between the Polyadenylation-Signal and Transcriptional-pause-site clusters found several expected connecting labels: Site(s), Region, Sequence, and Promoter. Specifically, two topics labeled Promoter that connected the Transcriptional-pause-site and Polyadenylation-Signal clusters were found to have identical top words: promoter, transcriptional, termination.

For each connecting concept, the implementation of the disclosed technology used in the test was able to identify relevant experts/authors as well as documents contributing to the topic (e.g., by identifying documents in which the top topic words were overrepresented as compared to their statistical frequency in the clusters containing those documents, as well as the authors of those documents). The highest contributing author for the topic labeled Promoter described above was N.J. Proudfoot in the Transcriptional-pause-site cluster and O. Leupin in the Polyadenylation-Signal cluster.

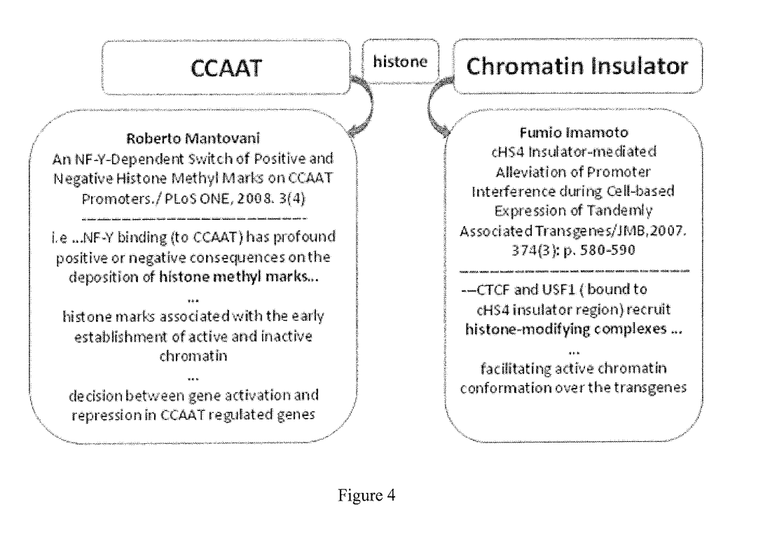

In addition to the expected connections which were identified in the above-described experiment, the implementation of the present technology used in this test provided some additional results. For example, it was somewhat unexpected to find CCAAT box, the sequence motif within certain promoters, as a partial solution to the promoter interference problem in the cluster Prevent transcriptional interference(14) (FIG. 2). An example of non-obvious connection Histone was found when performing a connectability analysis of the CCAAT and Chromatin-insulator clusters (FIG. 4). Here, chromatin insulator is a genetic boundary element that may separate active genes or active genes and advancing inactive chromatin. This connection can expand prior knowledge to an increased level of detail since the initial keywords did not make any reference to histone. Also, non-obvious connection Histone can serve as a catalyst (input) for innovation since it describes a function of CCAAT and chromatin insulators to bind proteins that mediate histone modification and control chromatin conformation. Here, controlled chromatin conformation results in transcriptionally active versus inactive DNA as shown in FIG. 4.

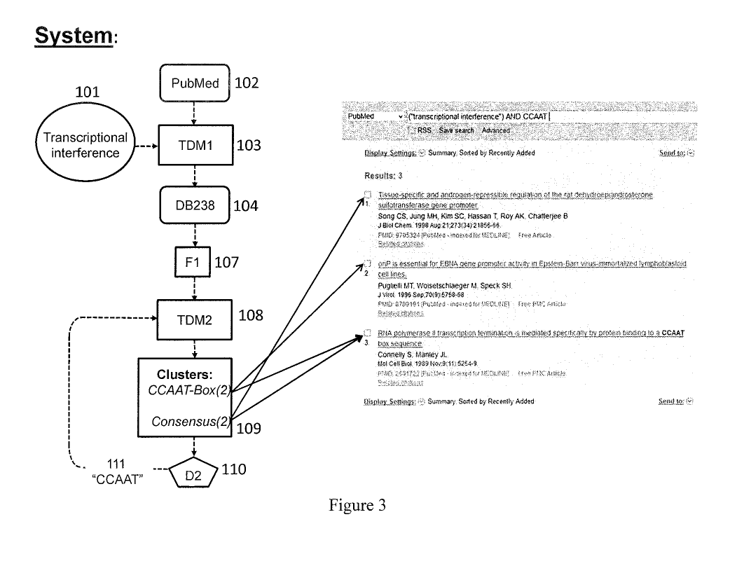

Other types of variations are also possible. For example, a process such as shown in FIG. 1 could be extended by using information gathered in a first iteration of the process (e.g., CCAAT as a solution to the transcriptional interference problem) in subsequent iterations performed with different underlying documents. In this example, documents related to CCAAT solution to the transcriptional interference problem were mined for. The implemented approach was to search initial database [102] PubMed for “transcriptional interference” term and create an analysis database (referred to in this example as DB238). Documents in analysis database DB238 are all related to transcriptional interference as they are found through process [101-103] using “transcriptional interference” as search term for TDM1 [103]. Analysis database DB238 was filtered [107] for English stopwords using the list of stopwords available at http://project.carrot2.org/download.html and the second text data mining process [108] was conducted to generate an initial set of clusters with labels. After this initial set of clusters was generated, based on labels of clusters from this initial set, CCAAT term was selected and used via [111] to repeat the second text data mining process [108]. This generated the following two clusters: CCAAT-Box(2) and Consensus(2) as illustrated in FIG. 3. Documents in the CCAAT-Box cluster are focused on CCAAT and are related to transcriptional interference. The two documents found in the CCAAT-Box cluster describe different roles of the CCAAT element in regulation of transcriptional interference between adjacent promoters. These documents are Connelly S. and Manley J. L., RNA polymerase II transcription termination is mediated specifically by protein binding to a CCAAT box sequence, Mol Cell Biol. 1989; 9(11): 5254-9 and Puglielli M T, Woisetschlaeger M and Speck S H, oriP is essential for EBNA gene promoter activity in Epstein-Barr virus-immortalized lymphoblastoid cell lines, J Virol. 1996; 70(9): 5758-68. Performing advanced “combined” search of PubMed's articles containing both “transcriptional interference” and “CCAAT” terms returned 3 abstracts (each of which was identified by the implementation of the discussed technology used in the test), two of which represent the CCAAT-Box cluster (FIG. 3). To find documents connecting with CCAAT-Box cluster, a new set of clusters was generated. This Transcriptional Interference(33) cluster was built from DB238 through process [104-107] using “transcriptional interference” as search term for TDM2 [108]. CCAAT-enhancer-binding-protein(68) and Promoter-contains-a-CCAAT-box(106) cluster were built from PubMed as initial database [102] through process [101-107] using “CCAAT” as search term for TDM1 [103] and TDM2 [108]. The selected clusters were filtered [1113] for English stopwords using the list available at en.wikipedia.org/wiki/Wikipedia:Historical_archive/Common_words,_searching_for_which_is_not_possible in prior to further analysis.

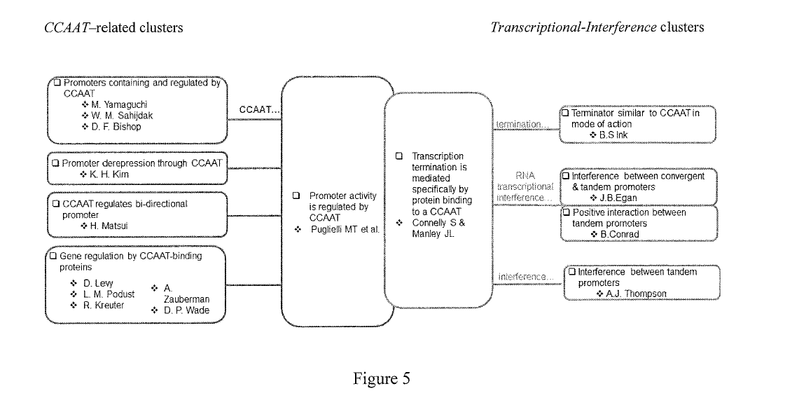

Results of the connectability analysis of CCAAT-Box cluster and Transcriptional Interference(33), CCAAT-enhancer-binding-protein(68) and Promoter-contains-a-CCAAT-box(106) clusters are presented in FIG. 5. The document by Connelly and Manley from CCAAT-box cluster is connected with documents from Transcriptional-Interference cluster, while the document by Puglielly et al. was found to have strongest connections with those from CCAAT-related clusters. This segregation of connections can be explained as follows. The document by Puglielly et al. teaches the use of CCAAT element as a transcriptional enhancer and it connects the documents that have more knowledge about CCAAT enhancer functions. The document by Connelly and Manley reports CCAAT function as a terminator directly involved in the prevention of interference from upstream promoter in tandem genes. Here, similarly labeled topics within documents from the Transcriptional-Interference cluster can be found. Concept Termination connects paper by Connelly and Manley on CCAAT function as terminator with paper by Ink and Pickup [B S Ink and D J Pickup. Transcription of a poxivirus early gene is regulated both by a short promoter element and by a transcriptional termination signal controlling transcriptional interference, J. Virol., 1989 vol. 63 no. 11 4632-4644] that describes another similar short terminator element found in poxivirus. Thus, the present system proved capable of enriching the PubMed search by finding several connectable documents.

Of course, variations in terms of repetitions (either of the overall process or of individual portions of the process of FIG. 1) or data sources are not the only types of variations which could be implemented based on this disclosure. To illustrate, consider a case in which the disclosed technology is applied to a database comprising a relatively small number of authored scientific documents, such as 11 full text theses relevant to phrases defining the promoter interference problem. In such a case, rather than simply clustering the documents as described above, the disclosed technology can be used for full text data mining by splitting the theses up into sections which can then be subjected to the type of analysis described previously in the context of FIG. 1. This splitting can also be performed in a variety of ways. These ways could include (a) treating each thesis as a single document, (b) creating a bag of author-defined sections (e.g., treating each paragraph in a thesis as a separate document), (c) compiling a bag of N-words sections (e.g., treating the first 600 words as one document, treating the second 600 words as another document, etc), and (d) assembling a bag of paragraphs (i.e., treating every paragraph in a thesis as a separate document).

The process discussed previously in the context of FIG. 1 could then be applied and, depending on the connections identified between the different portions of the documents, could result in identification of information such as connections and experts, or could be used to identify individual documents which seem particularly relevant to the problem at hand. For example, a database comprising 11 full text theses relevant to the following key phrases “transcriptional interference”, “promoter interference”, “promoter suppression” and “promoter occlusion” was created to illustrate how the disclosed technology can be used in data mining of large full-text documents such as PhD theses. Assembled paragraph-documents were stored in an analysis database, to be referred as DB_PhD6714, containing 6,714 paragraphs extracted out of 11 theses. Mining this analysis database using the clustering steps [107]-[109] for the “Promoter interference” search term returned 186 clusters, including those describing phenomena such as Transcriptional-Interference(163), Promoter-Interference(92), Promoter-Suppression(24), and Antisense-Transcriptional-Interference(19) as well as those potentially relevant for solutions: Vectors(52), Lentiviral-Vectors(30); Promoter-Lentiviral-Vector(23), and Eliminate-Promoter-Interference(12). Clusters labeled with phenomena can be used to provide a user with means to quickly find relevant information about the problem, while clusters with solutions can help a user to identify ways how to solve the problem. The cluster labeled Eliminate-Promoter-Interference(12) contained solutions to the promoter interference problem. In this cluster we found 7 paragraph-documents from abstract, results and discussion sections of a thesis entitled “Engineering lentiviral vectors for gene therapy and development of live cell arrays for dynamic gene expression profiling” by Jun Tian (2010). This cluster describes how to integrate partial solutions such as polyadenylation signal, terminator, insulator elements and transcription orientation considerations to address the challenges of the prompter interference problem in lentiviral gene transfer vectors.

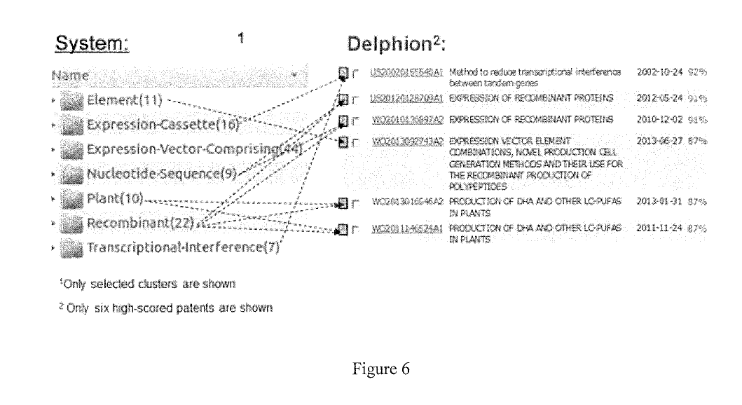

A system implemented using the disclosed technology can also be used to find meaningful connections among patents. In an experiment of this type of functionality, an analysis database of 417 patent abstracts with claims assembled from the Dephion's combined search for the “transcriptional interference” and “termination” was created. The retrieved documents were filtered [107] for English stopwords obtained as a combination of those available at en.wikipedia.org/wiki/Wikipedia:Historical_archive/Common words,_searching_for_which_is_not_possible and patft.uspto.gov/netahtml/PTO/help/stopword.htm. Then, the second text data mining process [108] was used to obtain clusters [109] of patents. FIG. 6 compares the sampled output from the tested implementation of the disclosed technology with that from Delphion. As shown in that figure, the tested implementation distributed patents scored by Delphion in clusters with meaningful labels.

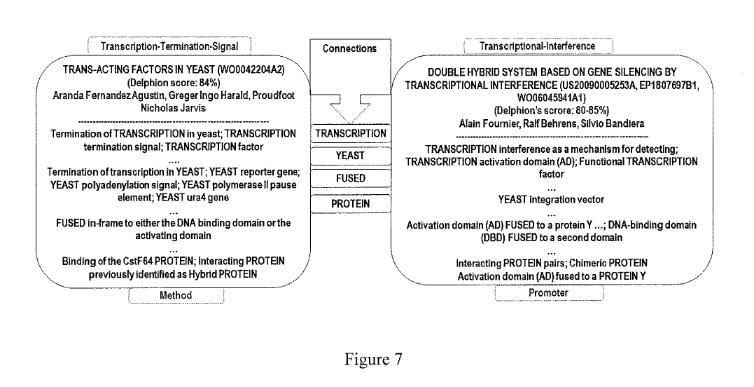

Clusters for further analysis can be selected based on their labels. The following clusters were found to be relevant to the “transcriptional interference” and “termination” initial search terms: Transcription-termination-signal(8), Method(3), Promoter(7) and Transcriptional-interference (7). The selected clusters were filtered via [113] for English stopwords obtained as a combination of those available at en.wikipedia.org/wiki/Wikipedia:Historical_archive/Common_words,_searching_{—}for_which_is_not_possible and patft.uspto.gov/netahtml/PTO/help/stopword.htm. Meaningful connections [117] between these clusters can be obtained via steps [114]-[116] from FIG. 1. Among obtained connections, there are several connections such as Transcription, Yeast, Fused, and Protein between Transcription-Termination-Signal(8) and Transcriptional-Interference (7) as shown in FIG. 7. These connections were then used to identify two patent documents: WO0042204 A2 “Trans-acting factors in yeast” (which describes genetic screening methods for the use in identification of trans-acting factors associated with the termination of transcription in yeast) and EP1807697 B1 “Double hybrid system based on gene silencing by transcriptional interference” (which describes modified yeast two-hybrid assay enabling detection of the interruption of protein-protein interaction). Thus, by applying the disclosed technology, two independent patent documents which use a combination of similar tools such as yeast expression systems, protein fusion, double hybrid assay and transcriptional interference as a method for screening were identified.

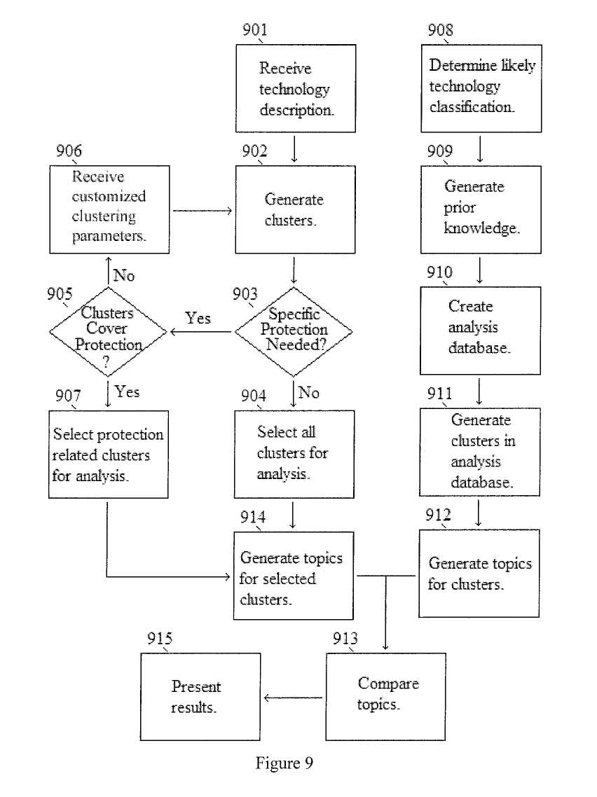

As another illustration of how the disclosed technology could be applied, it is also possible that a system implemented using the disclosed technology could be used to identify particular types of connections which might have legal or commercial significance. As an illustration of this, consider FIG. 9, which illustrates a method for using the disclosed technology to identify connections relevant to whether claims to an invention from some type of technology description (e.g., a patent application, a white paper, a thesis, etc) would be likely to be treated as obvious under 35 U.S.C. §103. In that method, after the technology description has been received [901] (e.g., uploaded by a user), it would be used to generate [902] a set of clusters (e.g., by breaking it up into pieces then treating those pieces as individual documents to be clusters, as described previously in the example of analysis of theses). Then, a check could be performed to determine if there was a particular area where protection for the invention from the technology description was needed. For example, if the technology description was a patent application filed by a startup to protect a product for solving the promoter interference problem, then the check [903] would likely indicate (e.g., because a user could provide input to that effect) that protection was needed in a specific area. Alternatively, if a technology description was a white paper prepared by a company which was more concerned with getting as much protection as possible than with getting protection for a specific type of product, then the check [903] would likely not indicate that protection was needed in a specific area.

After the check [903] of whether specific protection was needed, the process of FIG. 9 would proceed in one of two ways, depending on the results of that check. If specific protection was not needed, then all of the clusters generated from the technology description could be treated as relevant clusters which were selected [904] for further analysis. Alternatively, if specific protection was needed, the process of FIG. 9 would proceed with a further check [905] of whether the coverage of the previously generated clusters was sufficient. This could be done, for example, by checking the clusters against a set of keywords previously identified as relevant to the necessary protection to make sure that the clusters covered each of those keywords. If this second check [905] indicated that the clusters did not cover all concepts believed to be relevant to the necessary protection, the user could be informed of the concepts which did not appear to be covered and then given the option of proceeding with the process or providing customized clustering parameters (e.g., seed words, number of clusters to generate, clustering threshold) (or to take some other action, such as providing a revised technology description) which, once received [906], could be used to generate a new set of clusters with which the steps described previously could be repeated. Alternatively, if the second check [905] indicated that all concepts were covered (or if the user decided to proceed even without all concepts being covered), then the clusters with labels corresponding to the relevant concepts could be selected [907] as clusters to be subjected to further analysis.

In addition to this selection of clusters generated based on the technology description, the process of FIG. 9 also includes a set of steps which could be used to generate an analysis database for identifying topics which would be likely to be treated as obvious by one or ordinary skill in the art. The first of these steps is to determine [908] how a patent application seeking to protect an invention described in the technology description would likely be classified. This can be done, for example, by calculating the cosine similarity (or other similarity measure) between the technology description and sets of representative patents and published applications which had previously been classified by the USPTO. Then, after the technology description has been classified, prior knowledge of one of ordinary skill in the art relevant to that description is generated [909]. This can be done, for example, by identifying documents reflective of the knowledge of one of ordinary skill in the relevant art (e.g., if someone having a bachelor's degree in biology would be considered one of ordinary skill in the art to which the technology description pertains, then these documents could be identified as biology textbooks that someone would likely have been read by someone getting an undergraduate biology degree), then automatically extracting keywords from those documents in a manner such as described previously in the context of color matching.

Once the prior knowledge had been generated [909], it could be used to create [910] an analysis database of references which could potentially be used in arguing that claims to an invention from the technology description are obvious. This can be done by searching a database of patents and published applications for documents which are both (1) prior art relative to the technology description; and (2) in the same class as the that determined [908] previously for the technology description, or in a classification which was previously identified as relevant to the classification of the technology description. For example, if the technology description is a pending patent application, classified in subclass 400 of class 705 of the U.S. patent office's classification system (or a subclass which was indented under subclass 400 of class 705), the analysis database could be created [910] by searching for patents and published patent applications which had filing dates before that of the technology description, and which were classified in classes and subclasses identified as classes or subclasses to be searched in the relevant class definition from the USPTO (e.g., class 705/400, 705/1.1, and 235/7+).

Once the analysis database had been created [910] its contents could be clustered [911], and topics could be generated [912] for those clusters. These topics could then be compared [913] against one or more topics previously generated [914] for the clusters derived from the technology description which had been selected for analysis, and the results of this comparison could be presented [915] to the user. This presentation [915] of results could vary from implementation to implementation, and depending on what connections were found during the comparison [913] of topics. For example, in some implementations, if the comparison [913] reveals that, for each topic from the clusters derived from the original technology description, that topic was connected to at least one topic from the analysis database with at least a threshold level of similarity, the presentation of results could indicate that any claims to protect material in the technology description would likely be treated as obvious. Additionally or alternatively, the results presented [915] to the user could include identifications of documents from the prior art analysis database which appeared to be highly relevant to the prior art topics which matched the topics from the technology description.

The results presented [915] to the user could also (or alternatively) include information on the similarity scores between topics derived from the technology description and topics from the prior art analysis database. Such information could include, for example, whether there was a topic from the technology description which didn't appear to match any prior art topic with more than a threshold similarity (in which case the user could be informed that a claim with elements focusing on that topic appeared to have a relatively low chance of being treated as obvious). Similarly, if there was a cluster derived from the technology description which was not connected to any cluster from the prior art analysis database with more than a threshold level of similarity, then that cluster from the technology description could be identified to the user as reflecting a broad feature of the material from the technology description which appeared to be innovative and which could be a good subject on which to focus an independent claim. Of course, it is also possible that results of a process such as shown in FIG. 9 could be presented [915] in a manner which is not specific to the relevance of identified connections to the determination of whether an invention is likely to be treated as obvious. For example, the presentation [915] of results from a process such as illustrated in FIG. 9 could be achieved by presenting the user an interface which lists, for each connection between a pair of topics which was identified as having a similarity greater than some threshold value, a title for that connection (e.g., a label derived from the top words in the topics forming the connection) and the labels for the clusters from which the topics making up that connection were derived.

Of course, variations on how the disclosed technology could be used to identify particular types of connections with commercial or legal significance are not limited to variations on how the results of such identifications could be presented to a user. For example, while FIG. 9 illustrates the steps for generating prior knowledge [909], creating [910] a prior art analysis database, generating [911] clusters in that database, and generating [912] topics for those clusters as being performed in parallel with the reception [901] and processing [902]-[907], [914] of the technology description, it is possible that one or more of the steps dealing with the prior art [909]-[912] could be performed by an offline process entirely independent of the reception and processing of the technology description. That is, a system implemented using the disclosed technology could, in advance, perform steps such as generating [909] prior knowledge for a variety of different types of technology so that, when a user wished to analyze a technology description, the system could proceed by retrieving data it had previously stored for the relevant technology, rather than by having to generate that data in real time for the user.

As example of another type of variation on how the disclosed technology could be used to identify particular types of connections with commercial or legal significance, consider the use of the disclosed technology for identifying avenues of investigation which appear to be relatively likely to lead to inventions which would not be treated as obvious under 35 U.S.C. §103. This could be achieved by leveraging a technology classification system in essentially the opposite manner discussed in the context of FIG. 9. That is, instead of finding connections between topics from clusters of material from similar technology areas (i.e., the analysis database of prior art, and the clusters generated from the technology description), clusters made of documents from dissimilar technology areas (e.g., technology classes and subclasses which are neither the same nor identified as classes to be searched together) can be generated and tested for connections, with the connections between those dissimilar technology clusters being treated as potentially fruitful areas of research for inventions which could be treated as non-obvious combinations of non-analogous art.

Variations on the level of human involvement in the identification of connections with commercial or legal significance are also possible. Indeed, while the process of FIG. 9 could be executed by a computer in a purely automated fashion, preferably, methods such as shown in FIG. 9 will be performed in a context in which the ultimate determination of whether a particular type of connection exists (e.g., a connection between an invention and one or more prior art references which should be treated as rendering the invention obvious) would not be based solely on analysis by a computer. For example, it is expected that a process such as shown in FIG. 9 would have a tendency to be over-inclusive with respect to what technology it identifies as likely to be treated as obvious. There are a variety of reasons for this, including that the process of FIG. 9 does not account for indicia of non-obviousness such as commercial success or praise by others, that the process of FIG. 9 focuses on connections between individual topics rather than on inventions as a whole, and that where a document falls in the patent office's classification system is not determinative of whether it should be considered analogous art. Thus, a process of FIG. 9 will preferably be implemented in such a manner that any conclusions reached by a computer using that process can be reviewed and validated by a human being (e.g., through use of a result presentation interface which identifies connections between a technology description and the prior art, illustrates the relative strength of those connections, and provides prior art documents which appear relevant to those connections for a human to review). Further variations are also possible, and will be immediately apparent to, and could be made and used without undue experimentation by, those of ordinary skill in the art in light of this disclosure. Accordingly, the discussion of variations on FIG. 9, like the discussion of FIG. 9 itself, should be understood as being illustrative only, and should not be treated as limiting.

Turning now to FIG. 8, that figure illustrates a high-level architecture [800] which could be used by systems implemented based on the present disclosure. This architecture [800] can enable a user [801] to access a web-based interface [804] of the system through a network such as the internet [803] by using any local device with an internet browser [802] (e.g., a desktop computer, laptop computer, tablet computer, workstation, smartphone, etc). The web interface [804] provides secure access through which users can securely (e.g., in encrypted form) submit information such as keywords and key phrases to a server [805] that stores code [806] as well as results of searching or data mining such as an analysis database [104], and labeled information and authored connections [109], [115], and [117]. When a user [801] interacts with the web interface [804], the web interface is expected to receive prior knowledge from the user, pass it to code [806] and present to the user selected content from the analysis database [108] as well as labeled information and authored connections [109], [115], and [117] after completion of code execution. When a user [801] executes code [806], the code will be expected to communicate with an initial database [102] for extracting relevant documents in PDF, text, Microsoft Word, XML and/or other formats; to convert all extracted documents to plain text format; to assemble converted documents in an analysis database [104], and to perform data mining based on the disclosed technology to find labeled information and authored connecting concepts between documents or clusters of documents [109], [115], and [117]. Initial database can be in the form of a website with public access (e.g., PubMed, archives with Ph. D. theses, open access journals, and free patent databases) or a plug-in to external Application Programming Interface (e. g, ScienceDirect API). Preferably, in implementations following the architecture of FIG. 8, the user's local device [802] (e. g, computer, mobile phone) will not require special software, and will instead interact with the server via a web browser.

In light of the fact that this document has disclosed the inventors' technology by illustrative example, and that numerous modifications and alternate embodiments of the inventors' technology will occur to those skilled in the art, the claims set forth in this document, or any related document, should not be limited to the specific examples and embodiments set forth in this disclosure. Instead, those claims should be understood as being limited only by their terms when those terms are given their broadest reasonable interpretation or, if explicitly defined in the initial glossary or below, are given their explicit definitions.

### EXPLICIT DEFINITIONS

When used in the claims, “based on” should be understood to mean that something is determined at least in part by the thing that it is indicated as being “based on.” For a claim to indicate that something must be completely determined based on something else, it will be described as being “based EXCLUSIVELY on” whatever it is completely determined by.

When used in the claims, “computer” should be understood to refer to a device or group of devices for storing and processing data, typically using a processor and computer readable medium. In the claims, the word “server” should be understood as being a synonym for “computer,” and the use of different words should be understood as intended to improve the readability of the claims, and not to imply that a “server” is not a “computer.” Similarly, the various adjectives preceding the words “server” and “computer” in the claims are intended to improve readability, and should not be treated as limitations. For example, the use of the phrase “user computer” is for the purpose of improving readability, and not for the purpose of implying a need for particular physical distinctions between that computer and other types of computers.

When used in the claims “computer readable medium” should be understood to mean any object, substance, or combination of objects or substances, capable of storing data or instructions in a form in which they can be retrieved and/or processed by a device. A computer readable medium should not be limited to any particular type or organization, and should be understood to include distributed and decentralized systems however they are physically or logically disposed, as well as storage objects of systems which are located in a defined and/or circumscribed physical and/or logical space. A reference to a “computer readable medium” being “non-transitory” should be understood as being synonymous with a statement that the “computer readable medium” is “tangible”, and should be understood as excluding intangible transmission media, such as a vacuum through which a transient electromagnetic carrier could be transmitted. Examples of “tangible” or “non-transitory” “computer readable media” include random access memory (RAM), read only memory (ROM), hard drives and flash drives.

When used in the claims, “configure” should be understood to mean designing, adapting, or modifying a thing for a specific purpose. When used in the context of computers, “configuring” a computer will generally refer to providing that computer with specific data (which may include instructions) which can be used in performing the specific acts the computer is being “configured” to do. For example, installing Microsoft WORD on a computer “configures” that computer to function as a word processor, which it does using the instructions for Microsoft WORD in combination with other inputs, such as an operating system, and various peripherals (e.g., a keyboard, monitor, etc. . . . ).

When used in the claims, “means for automatically identifying connecting concepts” should be understood as a means+function limitation as provided for in 35 U.S.C. §112(f), in which the function is “automatically identifying connecting concepts” and the corresponding structure is a computer configured to perform an algorithm having steps of (1) creating an analysis database comprising labeled information items based on input representing prior knowledge, (2) determining and assigning labels to topics from the information items in the analysis database, and (3) identifying connections made up of pairs of topics from different information items based on the similarity of those topics to each other. Examples of algorithms which could be performed by a “means for automatically identifying connecting concepts” are depicted in FIGS. 1, 2 and 9, discussed in the corresponding text, and illustrated in the color matching and transcription interference examples.

When used in the claims, “means for automatically identifying legally or commercially significant connections” should be understood as a means+function limitation as provided for in 35 U.S.C. §112(f), in which the function is “automatically identifying legally or commercially significant connections” and the corresponding structure is a computer configured to perform an algorithm such as described previously in the context of the “means for automatically identifying connecting concepts” in which the pairs of topics are taken from information items likely to have a legally or commercially significant relationship to each other. An example of this is provided in FIG. 9 and that figure's associated discussion, in which connections are made up of pairs of topics which contain a topic from a technology description, and a topic from an analysis database of reference likely to be treated as analogous art relative to that technology description.

When used in the claims, a “set” should be understood to refer to a number, group or combination of zero or more things of similar nature, design, or function.

1. A method comprising:
a) receiving a set of keywords representing prior knowledge;
b) preparing an analysis database comprising a set of information items by performing a set of acts comprising:
i) identifying one or more relevant documents by searching one or more existing initial databases utilizing the set of keywords;
ii) for each relevant document identified by searching one or more existing initial databases utilizing the set of keywords;
A) retrieving a copy of that document; and
B) separating the retrieved copy of that document into individual paragraphs;
and
iii) clustering the individual paragraphs into a plurality of labeled clusters, wherein the information items are the labeled clusters;
c) generating a plurality of topics, wherein the plurality of topics comprises multiple topics for each information item comprised by the analysis database;
d) calculating a similarity for each pair of topics from a plurality of pairs of topics, wherein each pair of topics from the plurality of pairs of topics comprises topics from different information items from the analysis database;
e) determining, for each pair of topics from the plurality of pairs of topics, based on the similarity calculated for that pair of topics, whether that pair of topics represents a connection to include in a result set;
f) presenting the result set, wherein presenting the result set comprises, for each pair of topics determined to represent a connection to include in the result set:
i) presenting a connection label comprising one or more keywords determined based on that pair of topics; and
ii) identifying the information items from which the topics from that pair of topics were obtained.

2. The method of claim 1 further comprising:
a) generating a modified set of keywords based on the content of the analysis database; and
b) repeating step (b) from claim 1 using the modified set of keywords.

3. The method of claim 2, wherein the method comprises performing each of steps (b) and (c) from claim 1 at least two times before performing any of steps (d), (e) or (f) from claim 1.

4. The method of claim 1 wherein:
a) for each labeled cluster, the label for that cluster is determined based on high frequency terms appearing in that cluster; and
b) the method further comprises filtering out stopwords from a set of documents obtained by searching the one or more existing initial databases for relevant documents using the set of keywords.

5-6. (canceled)

7. The method of claim 1, wherein the result set comprises, for at least one pair of topics determined to represent a topic to include in the result set, an indication of an author for that topic.

8. The method of claim 1 further comprising, prior to generating the plurality of topics, filtering out stopwords from each information item stored in the analysis database.

9. The method of claim 1 wherein:
a) generating the plurality of topics comprises, for each item of information comprised by the analysis database, selecting the multiple topics for that item of information using a random number generator and a random seed; and
b) the method comprises using repeating step (c) from claim 1 with a different random seed.

10. The method of claim 1, wherein the method comprises repeating at least steps (d) and (e) of claim 1 one or more times unless:
a) the result set comprises at least one unexpected connection; or
b) no pairs of topics are determined to represent a connection to include in the result set.

11. A system comprising:
a) a user computer configured to access and to interact with an interface operable to:
i) provide a set of keywords to a set of one or more server computers;
ii) cause the set of one or more server computers to perform a set of data analysis steps using the set of keywords; and
iii) present a result set determined based on performance of the set of data analysis steps;
and
b) the set of one or more server computers, wherein the set of one or more server computers is configured to, based on receiving an input from the user computer via the interface:
i) perform the set of data analysis steps, the set of data analysis steps comprising:
A) creating an analysis database comprising a set of information items by performing a set of acts comprising:
I) identifying one or more relevant documents by searching one or more preexisting databases utilizing the set of keywords;
II) for each relevant document identified by searching one or more existing initial databases utilizing the set of keywords:
1) retrieving a copy of that document; and
2) separating the retrieved copy of that document into individual paragraphs;
and
III) clustering the individual paragraphs into a plurality of labeled clusters, wherein the information items are the labeled clusters;
B) generating a plurality of topics, wherein the plurality of topics comprises multiple topics for each information item comprised by the analysis database;
C) calculating a similarity for each pair of topics from a plurality of pairs of topics, wherein each pair of topics from the plurality of pairs of topics comprises topics from different information items from the analysis database;
D) determining, for each pair of topics from the plurality of pairs of topics, based on the similarity calculated for that pair of topics, whether that pair of topics represents a connection to include in the result set;
ii) send the result set to the user computer, wherein the result set comprises, for each pair of topics determined to represent a connection to include in the result set:
A) a connection label comprising one or more keywords determined based on that pair of topics; and
B) identification of the information items from which the topics from that pair of topics were obtained.

12. The system of claim 11 further comprising a security module adapted to allow users to securely submit keywords and keyphrases and securely store results of a search or data mining.

13. The system of claim 11, wherein:
a) for each labeled cluster, the label for that cluster is determined based on high frequency terms appearing in that cluster;
b) the set of one or more server computers is further configured to filter out stopwords from a set of documents obtained by searching the one or more preexisting databases for relevant documents using the set of keywords.

14. (canceled)

15. The system of claim 11, wherein the result set the set of one or more server computers is configured to send to the user computer comprises, for at least one pair of topics determined to represent a topic to include in the result set, an indication of an author for that topic.

16. The system of claim 11, wherein the one or more server computers is configured to, prior to generating the plurality of topics, filter out stopwords from each information item stored in the analysis database.

17. The system of claim 11, wherein the one or more server computers is configured to generate a plurality of topics by setting a different seed set for a random number generator used in topic selection.

18. A machine comprising:
a) a user computer configured to present an interface operable by a user to:
i) provide input to a means for automatically identifying connecting concepts; and
ii) receive a result from the means for automatically identifying connecting concepts;
and
b) the means for automatically identifying connecting concepts.

19. The machine of claim 18 wherein the means for automatically identifying connecting concepts is a means for automatically identifying legally or commercially significant connections.

20. The machine of claim 18, wherein the means for automatically identifying connecting concepts comprises means for clustering individual paragraphs from a plurality of documents identified using prior knowledge into labeled clusters.

21. The method of claim 1, wherein:
a) generating the plurality of topics:
i) is performed after preparing the analysis database; and
ii) for each information item in the analysis database, comprises creating the multiple topics for that information item based on the content of that information item; and
b) for each pair of topics for which the similarity for that pair of topics is calculated:
i) the similarity which is calculated for that pair of topics is the similarity of the topics in that pair of topics to each other; and
ii) the multiple topics for each information item from which the topics in that pair of topics are taken are different from each other.
